(19) United States
(12) Patent Application Publication
(10) Pub. No.: US 2025/0065680 A1
(43) Pub. Date: Feb. 27, 2025

(54) Work Vehicle

(71) Applicant: Kubota Corporation, Osaka-shi (JP)

(72) Inventors: Hiroyuki Suzuki, Sakai-shi (JP); Akira Tominaga, Sakai-shi (JP)

(21) Appl. No.: 18/812,017

(22) Filed: Aug. 22, 2024

(30) Foreign Application Priority Data
Aug. 23, 2023 (JP) 2023-135495

(51) Int. Cl. B60G 7/02

(52) U.S. Cl. CPC B60G 7/02; B60G 2204/143

(57) ABSTRACT

A work vehicle includes a gap filler in the form of a ring disposed between holders and an end portion of a coupling cylinder and fitted around a shaft. The gap filler fills the gap between the holders and the end portion of the coupling cylinder. The gap filler includes an outer portion as a cover portion fitted around the end portion of the coupling cylinder in such a manner as to cover the end portion of the coupling cylinder along its entire circumference.

### CROSS-REFERENCE TO RELATED APPLICATION

This application claims priority to Japanese Patent Application No. 2023-135495 filed Aug. 23, 2023, the disclosure of which is hereby incorporated by reference in its entirety.

### BACKGROUND OF THE INVENTION

### Field of the Invention

The present invention relates to a work vehicle.

### Description of Related Art

As disclosed in Japanese Unexamined Patent Application Publication, Tokukai, No. 2012-25226 (Patent Literature 1), a work vehicle (that is, a multipurpose work vehicle) may include suspension devices each including an upper arm, a lower arm, and a knuckle arm. The upper and lower arms are each held by a body frame in such a manner as to be swingable up and down. The knuckle arm is coupled to respective free end portions of the upper and lower arms and holds a wheel.

A work vehicle of this type may include for each of the upper and lower arms a pair of holders, a shaft held by the holders, a coupling cylinder disposed between the holders and rotatably fitted around the shaft, and a bushing between the shaft and the coupling cylinder. The upper and lower arms are each so coupled to its corresponding coupling cylinder as to be coupled to the corresponding shaft with use of the coupling cylinder. The upper and lower arms are thereby each held by the corresponding holders in such a manner as to be swingable up and down.

### Patent Literature 1:

Japanese Unexamined Patent Application Publication, Tokukai, No. 2012-25226

### SUMMARY OF THE INVENTION

Conventional work vehicles including a swingable member such as the upper and lower arms described above are provided with grease sealed up and receive grease regularly to reduce wear of the bushing. The work vehicles also have the bushing replaced regularly. Sealing up grease increases costs. The work vehicles require troublesome work of regular maintenance.

The present invention provides a work vehicle that allows a bushing to be used for an extended period of time and that is inexpensive.

A work vehicle according to the present invention includes: a pair of holders; a shaft held by the holders; a coupling cylinder disposed between the holders and rotatably fitted around the shaft; a swingable member coupled to the coupling cylinder in such a manner as to be swingably coupled to the shaft with use of the coupling cylinder; a bushing between the shaft and the coupling cylinder; and a gap filler in a form of a ring fitted around the shaft and positioned in and filling a gap between the holders and an end portion of the coupling cylinder, the gap filler including an outer portion as a cover portion fitted around the end portion in such a manner as to cover the end portion along an entire circumference thereof.

The above configuration involves a gap filler filling the gap between the coupling cylinder and the holders and including a cover portion covering an end portion of the coupling cylinder. The gap filler thus prevents entry of dust into the bushing to prevent the bushing from wearing out easily, thereby allowing the bushing to be used for an extended period of time. Simply using a gap filler prevents the bushing from wearing out easily. This eliminates the need to seal up or regularly add grease, which reduces costs.

The work vehicle may preferably be further configured such that the gap filler is fixed so as not to move together with the coupling cylinder in response to a swing of the swingable member.

If the gap filler were configured to rotate together with the coupling cylinder rotating due to a swing of the swingable member, the rotation of the gap filler would let in dust. With the above configuration, the gap filler is configured to not rotate. This prevents entry of dust and wear of the bushing caused by adhesion of dust.

The work vehicle may preferably be further configured such that the bushing includes an end portion as a flange portion between the gap filler and the end portion of the coupling cylinder.

With the above configuration, the flange portion prevents contact between the gap filler and the end portion of the coupling cylinder. This allows the coupling cylinder to rotate smoothly and the swingable member to swing easily.

The work vehicle may preferably further include: a collar disposed around the shaft and fitted in the bushing.

A swing of the upper swingable member rotates the coupling cylinder, which in turn applies force to the bushing for movement together with the coupling cylinder. The collar, in response, allows the bushing to slide thereon to prevent the bushing from receiving force for twisting the bushing. The collar, in other words, prevents the bushing from being damaged due to twisting force.

The work vehicle may preferably be further configured such that the swingable member is held by a body frame of the work vehicle with the coupling cylinder, the shaft, and the holders in-between, and the work vehicle further includes a wheel support disposed at a free end portion of the swingable member and holding a wheel of the work vehicle in such a manner that the wheel is rotatable.

The above configuration allows each wheel to be attached to the body frame with the swingable member in-between in such a manner as to be capable of being lifted and lowered. This allows the work vehicle to travel easily on rough terrain.

### BRIEF DESCRIPTION OF THE DRAWINGS

FIG. 1 is a left side view of a utility vehicle.

FIG. 2 is a rear view of a structure for holding a pair of left and right rear wheels.

FIG. 3 is a plan view of a structure for holding a pair of left and right rear wheels.

FIG. 4 is a perspective view of a suspension device.

FIG. 5 is a cross-sectional view of a structure for holding an upper swingable member and a lower swingable member.

### DESCRIPTION OF THE INVENTION

The description below deals with an example embodiment of the present invention with reference to drawings.

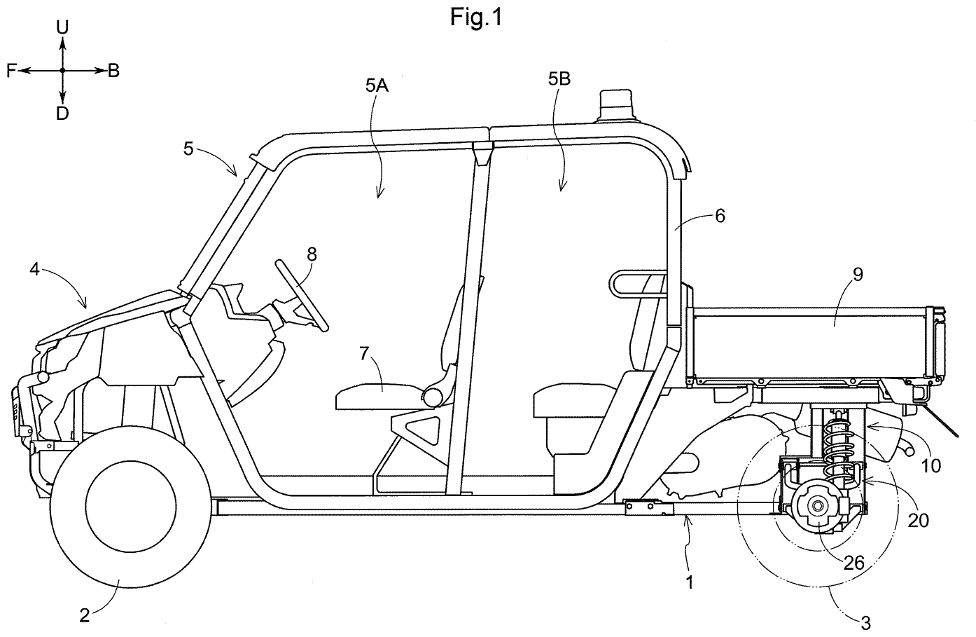

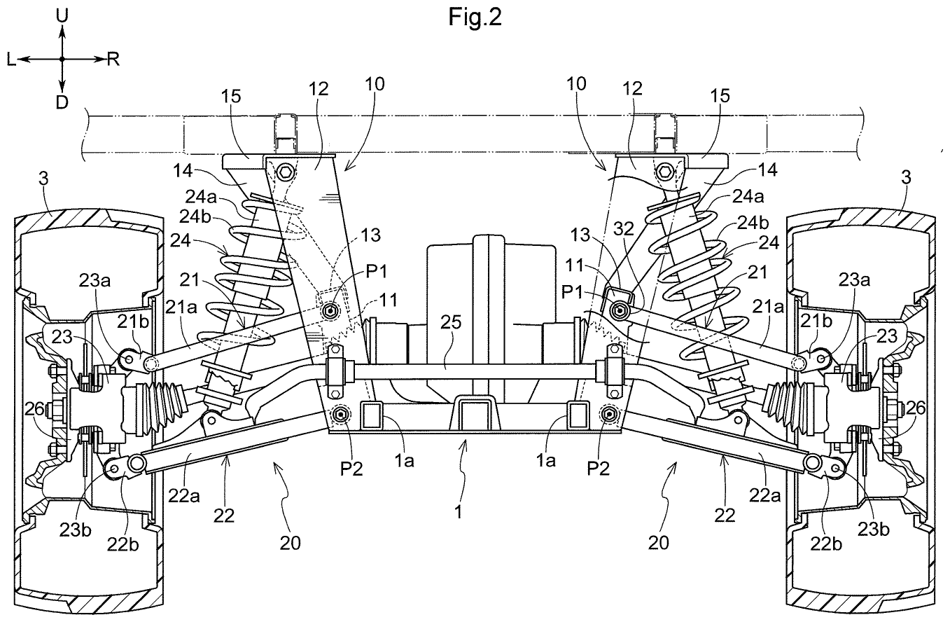

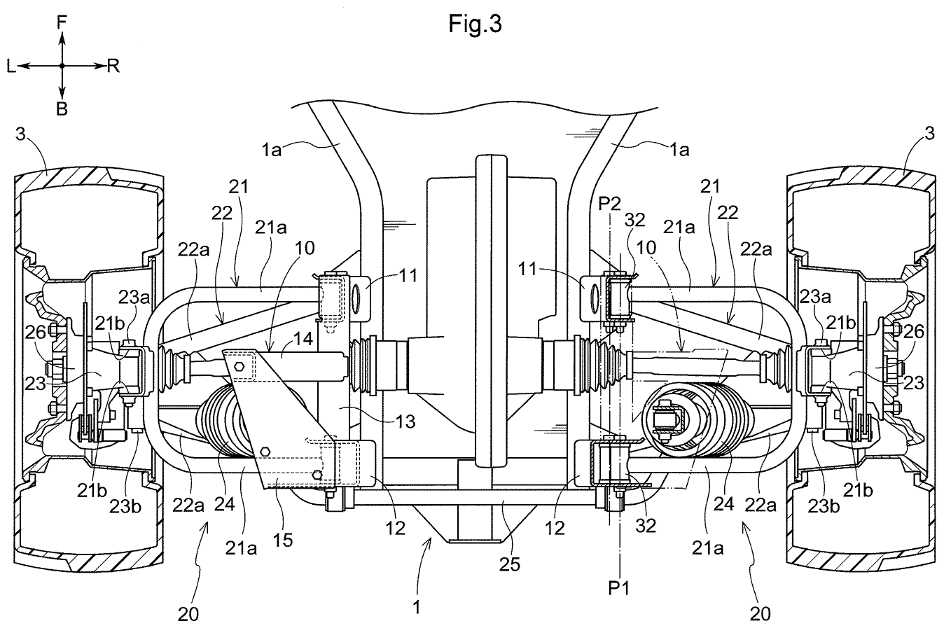

The embodiment described below is a utility vehicle (which is an example of the “work vehicle”) including a body. Drawings such as FIGS. 1 and 3 show arrow F to indicate the forward side of the body and arrow B to indicate the backward side of the body. Drawings such as FIGS. 1 and 2 show arrow U to indicate the upward side of the body and arrow D to indicate the downward side of the body. Drawings such as FIGS. 2 and 3 show arrow L to indicate the left side of the body, which corresponds to the front side of FIG. 1. Drawings such as FIGS. 2 and 3 show arrow R to indicate the right side of the body, which corresponds to the back side of FIG. 1. The left-right direction of the body corresponds to the width direction of the body.

### Overall Configuration of Utility Vehicle

FIG. 1 illustrates a utility vehicle for multiple purposes such as cargo transport and recreation. The utility vehicle includes a body frame 1, a pair of left and right front wheels 2, a pair of left and right rear wheels 3, and a body 4. The front wheels 2 are held by a front portion of the body frame 1, and are turnable and drivable. The rear wheels 3 are held by a back portion of the body frame 1, and are drivable. The utility vehicle includes a driver section 5 disposed at a portion of the body 4 which portion is between the front wheels 2 and the rear wheels 3. The driver section 5 includes a front driver section 5A, a back driver section 5B, and a roll-over protective structure (ROPS) 6 that defines respective driver spaces of the front and back driver sections 5A and 5B. The front driver section 5A includes a driver's seat 7 and a steering wheel 8 for use to change the direction of the front wheels 2. The utility vehicle includes a cargo box 9 backward of the driver section 5 relative to the body 4.

As illustrated in FIGS. 2 and 3, the body frame 1 includes a pair of left and right rear-wheel holding frame members 10. The utility vehicle includes a pair of left and right suspension devices 20 extending from the respective rear wheels 3 to the respective rear-wheel holding frame members 10. The rear wheels 3 are held by the body frame 1 with the respective suspension devices 20 in-between, and are capable of being lifted and lowered relative to the body 4.

The rear-wheel holding frame members 10 are, as illustrated in FIG. 1, at a back portion of the body frame 1. The rear-wheel holding frame members 10, as illustrated in FIGS. 2, 3, and 4, each include a first frame strut 11, a second frame strut 12, a reinforcing frame portion 13, a third frame strut 14, and a stay 15. The first frame strut 11 stands on a back portion of a main frame member 1a included in the body frame 1 and extending in the front-back direction of the body 4. The second frame strut 12 stands on the main frame member 1a and backward of the first frame strut 11 relative to the body 4. The reinforcing frame portion 13 couples an upper end portion of the first frame strut 11 to a vertically intermediate portion of the second frame strut 12. The third frame strut 14 stands on an intermediate portion of the reinforcing frame portion 13. The stay 15 is coupled to an upper end portion of the second frame strut 12 and the third frame strut 14.

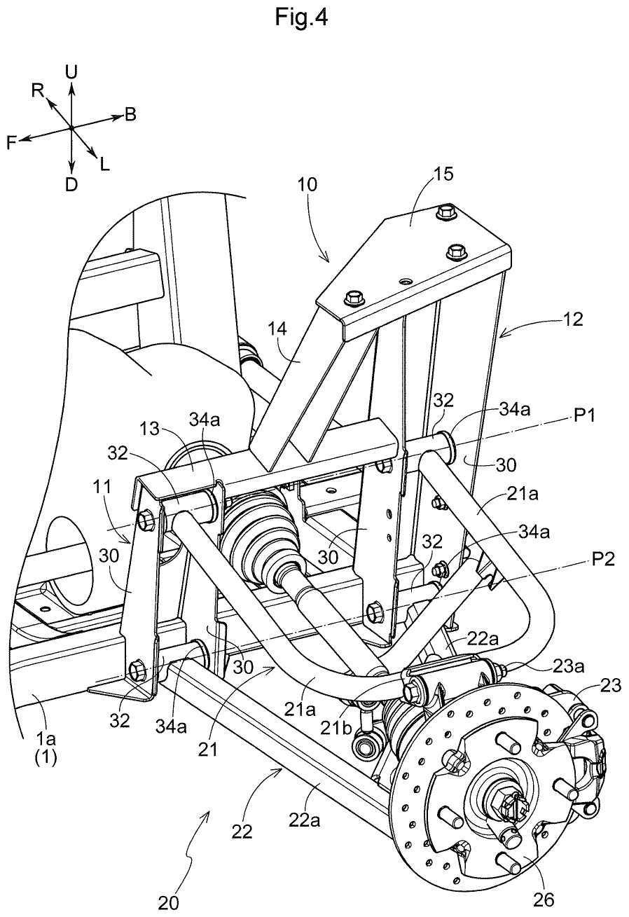

The suspension devices 20, as illustrated in FIGS. 2, 3, and 4, each include an upper swingable member 21, a lower swingable member 22, a wheel support 23, and a cushion mechanism 24. The upper swingable member 21 is held by the first and second frame struts 11 and 12 and swingable up and down. The lower swingable member 22 is below the upper swingable member 21, and is held by the first and second frame struts 11 and 12 and swingable up and down. The wheel support 23 is coupled to the respective free end portions of the upper and lower swingable members 21 and 22. The cushion mechanism 24 is coupled to the lower swingable member 22 and the stay 15. The cushion mechanism 24 includes a shock absorber 24a and a cushion spring 24b. The utility vehicle includes a stabilizer 25 coupled to the left and right lower swingable members 22. FIG. 4 omits the cushion mechanism 24.

As illustrated in FIGS. 2 and 3, the upper swingable member 21 is provided at its free end portion with a pair of holders 21b. The wheel support 23 is provided with a coupler shaft 23a extending in the front-back direction of the body 4. The wheel support 23 includes an upper portion coupled to the holders 21b and is swingable about the coupler shaft 23a. The lower swingable member 22 is provided at its free end portion with a pair of holders 22b. The wheel support 23 is provided with a coupler shaft 23b extending in the front-back direction of the body 4. The wheel support 23 includes a lower portion coupled to the holders 22b and is swingable about the coupler shaft 23b. The wheel support 23 includes a flange 26 to and from which the corresponding rear wheel 3 is attachable and detachable and which is drivable to rotate.

The wheel support 23 is coupled to the corresponding rear-wheel holding frame member 10 with components such as the upper and lower swingable members 21 and 22 in-between in such a manner as to be capable of being lifted and lowered. Attaching the corresponding rear wheel 3 to the flange 26 allows the rear wheel 3 to be held by the corresponding rear-wheel holding frame member 10 in such a manner as to be capable of being lifted and lowered.

The upper swingable member 21, as illustrated in FIGS. 2, 3, and 4, includes a pair of front and back arms 21a apart from each other in the front-back direction of the body 4 and including respective free end portions coupled to each other. The upper swingable member 21 for the present embodiment is in the form of a steel pipe bent in a U shape in a plan view. The front arms 21a is coupled to the first frame strut 11 in such a manner as to be swingable up and down, whereas the back arm 21a is coupled to the second frame strut 12 in such a manner as to be swingable up and down. This allows the upper swingable member 21 to be held by the first and second frame struts 11 and 12 in such a manner as to be swingable up and down.

The lower swingable member 22, as illustrated in FIGS. 2, 3, and 4, includes a pair of front and back arms 22a apart from each other in the front-back direction of the body 4 and including respective free end portions coupled to each other. The lower swingable member 22 for the present embodiment is in the form of two or more steel pipes coupled to each other in a V shape in a plan view. The front arms 22a is coupled to the first frame strut 11 in such a manner as to be swingable up and down, whereas the back arm 22a is coupled to the second frame strut 12 in such a manner as to be swingable up and down. This allows the lower swingable member 22 to be held by the first and second frame struts 11 and 12 in such a manner as to be swingable up and down.

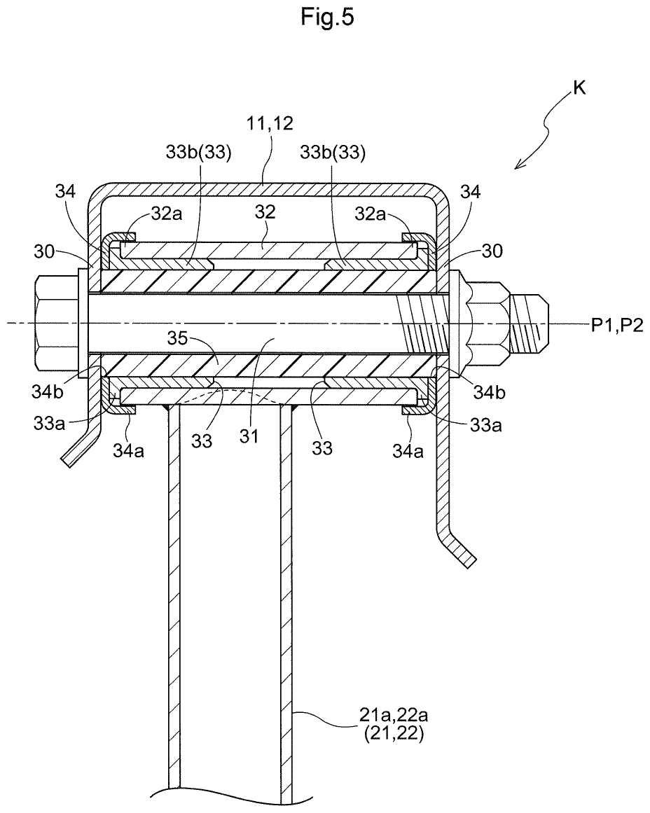

The front arm 21a is coupled to the first frame strut 11 with use of a coupling structure K illustrated in FIG. 5.

Specifically, the coupling structure K, as illustrated in FIG. 5, includes a pair of holders 30 provided for the first frame strut 11, a shaft 31 held by the holders 30, a coupling cylinder 32 disposed between the holders 30 and fitted around the shaft 31, a bushing unit 33 between the coupling cylinder 32 and the shaft 31, and a pair of gap fillers 34 at the opposite ends of the coupling cylinder 32.

The holders 30 are next to each other with a predetermined distance in-between along the swing axis P1 of the upper swingable member 21. The shaft 31 has an axis coinciding with the swing axis P1.

The coupling cylinder 32 is rotatably fitted around the shaft 31 and coupled to the arm 21a such that the arm 21a is swingably coupled to the shaft 31.

The coupling structure K includes a collar 35 disposed around the shaft 31 and fitted in the bushing unit 33. A swing of the upper swingable member 21 rotates the coupling cylinder 32, which in turn applies force to the bushing unit 33 for rotation together with the coupling cylinder 32. The collar 35, in response, allows the bushing unit 33 to slide thereon to prevent the bushing unit 33 from receiving force for twisting the bushing unit 33.

The gap fillers 34 are each a ring fitted around the collar 35 and positioned in and filling a gap between an end portion 32a of the coupling cylinder 32 and the corresponding holder 30. Each gap filler 34 includes an outer portion as a cover portion 34a fitted around the corresponding end portion 32a. The cover portion 34a is in the form of a ring that covers the end portion 32a along its entire circumference. The gap filler 34 prevents entry of dust toward the bushing unit 33 through a space between the end portion 32a and the cover portion 34a and a space between the holder 30 and the end portion 32a.

The bushing unit 33 includes opposite end portions each as a flange portion 33a between the corresponding gap filler 34 and the corresponding end portion 32a. The flange portion 33a prevents contact between the gap filler 34 and the end portion 32a and ensures smooth rotation of the coupling cylinder 32.

The bushing unit 33, as illustrated in FIG. 5, includes two divisional bushings 33b disposed at the respective opposite ends of the coupling cylinder 32 and each assemblable by inserting that end of the divisional bushing 33b at which the flange portion 33a is absent into a space between the coupling cylinder 32 and the collar 35.

When a swing of the upper swingable member 21 rotates the coupling cylinder 32, a rotation of the gap fillers 34 together with the coupling cylinder 32 would let dust into a space between the gap fillers 34 and the holders 30. To prevent this, the gap fillers 34 are fixed to the collar 35 so as not to move together with the coupling cylinder 32. Specifically, the collar 35 is fastened to the holders 30 by the fastening force of the shaft 31 as a screw shaft so as not to rotate relative to the holders 30. The gap fillers 34 each have an attachment hole 34b for the gap filler 34 to be fitted around the collar 35 for attachment. The gap fillers 34 are each fixed to the collar 35 through adjustment of the fit tolerance between the attachment hole 34b and the outer diameter of the collar 35. The collar 35 is fixable to the holders 30 so as not to rotate with use of not only the shaft 31 to fasten the collar 35 to the holders 30 but also the fit tolerance between the axial dimension of the collar 35 and the distance between the holders 30.

The back arm 21a is coupled to the second frame strut 12 with use of a coupling structure identical to the coupling structure K, except that the holders 30 are provided for the second frame strut 12 and are next to each other with a predetermined distance along the swing axis P1 of the upper swingable member 21. The shaft 31 has an axis coinciding with the swing axis P1.

The front arm 22a is coupled to the first frame strut 11 with use of a coupling structure identical to the coupling structure K, except that the holders 30 are next to each other with a predetermined distance along the swing axis P2 of the lower swingable member 22. The shaft 31 has an axis coinciding with the swing axis P2.

The back arm 22a is coupled to the second frame strut 12 with use of a coupling structure identical to the coupling structure K, except that the holders 30 are provided for the second frame strut 12 and are next to each other with a predetermined distance along the swing axis P2 of the lower swingable member 22. The shaft 31 has an axis coinciding with the swing axis P2.

### Alternative Embodiments

(1) The embodiment described above is an example of the present invention being applied to the structure in which the upper and lower swingable members 21 and 22 for the rear wheels are held by the body frame 1. The present invention is, however, not limited to such a configuration, and may alternatively be applied to, for instance, a structure in which upper and lower swingable members of suspension devices for the front wheels 2 are held by the body frame 1, a structure in which the wheel support 23 is swingably supported by the upper and lower swingable members 21 and 22, or a structure in which the cushion mechanism 24 is swingably supported by the lower swingable member 22, the upper swingable member 21, or the body frame 1.

(2) The embodiment described above is an example in which the gap fillers 34 do not move together with the coupling cylinder 32. The gap fillers 34 may alternatively be configured to move together with the coupling cylinder 32.

(3) The embodiment described above is an example in which the bushing unit 33 includes flange portions 33a. The bushing unit 33 may alternatively omit the flange portions 33a.

(4) The embodiment described above is an example including a collar 35. The present invention may alternatively omit the collar 35.

### INDUSTRIAL APPLICABILITY

The present invention is applicable to not only utility vehicles but also any other work vehicle such as transport vehicles.

### REFERENCE SIGNS LIST

1 Body frame
21 Upper swingable member (swingable member)
22 Lower swingable member (swingable member)
23 Wheel support
30 Holder
31 Shaft
32 Coupling cylinder
32a End portion
33 Bushing
33a Flange portion
34 Gap filler
34a Cover portion
35 Collar

1. A work vehicle, comprising:
a pair of holders;
a shaft held by the holders;
a coupling cylinder disposed between the holders and rotatably fitted around the shaft;
a swingable member coupled to the coupling cylinder in such a manner as to be swingably coupled to the shaft with use of the coupling cylinder;
a bushing between the shaft and the coupling cylinder; and
a gap filler in a form of a ring fitted around the shaft and positioned in and filling a gap between the holders and an end portion of the coupling cylinder, and
wherein the gap filler comprises an outer portion as a cover portion fitted around the end portion in such a manner as to cover the end portion along an entire circumference thereof.

2. The work vehicle according to claim 1, wherein:
the gap filler is fixed so as not to move together with the coupling cylinder in response to a swing of the swingable member.

3. The work vehicle according to claim 1, wherein:
the bushing comprises an end portion as a flange portion between the gap filler and the end portion of the coupling cylinder.

4. The work vehicle according to claim 1, further comprising:
a collar disposed around the shaft and fitted in the bushing.

5. The work vehicle according to claim 1, wherein:
the swingable member is held by a body frame of the work vehicle with the coupling cylinder, the shaft, and the holders in-between, and
the work vehicle further comprises a wheel support disposed at a free end portion of the swingable member and holding a wheel of the work vehicle in such a manner that the wheel is rotatable.
